(19) United States
(12) Patent Application Publication
(10) Pub. No.: US 2005/0027568 A1
(43) Pub. Date: Feb. 3, 2005

(54) System, method and computer program product for managing patient information

(76) Inventor: David W. Dorris, Effingham, IL (US)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/629,495

(22) Filed: Jul. 29, 2003

(51) Int. Cl. G06F 17/60

(52) U.S. Cl. 705/3

(57) ABSTRACT

A system, method and computer program product are provided for managing at least one patient record, each patient record including patient information. The system includes a patient processor, an administrator processor coupled to the patient processor across a network, and an electronic database coupled to the administrator processor. The patient processor capable of receiving patient information for a patient record, and storing the received patient information in a queue. In turn, the administrator processor is capable of receiving a determination whether to accept or reject the patient information in the queue. If the patient information is accepted, the electronic database is capable of storing the patient information.

### FIELD OF THE INVENTION

The present invention relates generally to systems and methods of managing patient information and, more particularly, relates to systems, methods and computer program products for managing patient information by providing increased patient access to respective information.

### BACKGROUND OF THE INVENTION

In industries that provide services to patients, such as the medical and dental industries, acquiring and maintaining up-to-date information relating to such patients is often very important in business management. For example, in the dental industry, dental practices must generally obtain and maintain information regarding their patients, such as contact information, medical history information, insurance information and the like. In the medical and dental industries, for example, information regarding patients is traditionally provided by the respective patients, such as by completing a patient record form upon entering the medical or dental office for an appointment. In this regard, patients are often presented with a form that includes fields for patients to enter requested information, such as the information identified above.

Conventionally, medical and dental practices maintained patient information in paper files that included patient records, which contained patient information provided by the patient, as well as patient information gathered during appointments to the doctor and dentist, respectively. To maintain such information, then, the medical and dental practices were required to manually generate records, or manually update previously generated records. As a result, maintaining patient information often required an undesirable amount of space for storing paper files, and consumed an undesirable amount of time.

To overcome many of the drawbacks of paper files, many patient management software programs have been developed. Programs such as Eaglesoft Practice Management (distributed by Eaglesoft), PracticeWorks Office and SoftDent (both distributed by Practiceworks, Inc.) and Dentrix (distributed by Dentrix Dental Systems, Inc.) allow dental practices to electronically manage patients, as well as their practices. In this regard, many patient management software programs allow medical and dental practices to maintain patient information in an electronic database, thus reducing the need for maintaining and storing paper files.

Whereas patient management software programs have overcome many of the drawbacks of conventional paper files, such software programs have drawbacks. As indicated above, such software programs allow medical and dental practices to maintain patient records in an electronic database. Operating such software programs, however, still typically requires patients to complete a paper-based patient record form upon entering the medical or dental office for an appointment, with the patient typically completing such a form (or at least updating information on such a paper-based form) each time the patient enters the office for an appointment. The information provided by the patient must then typically be manually entered into the patient management software program by staff of the medical or dental office to thereby store the patient information in the electronic database. Having patients complete patient record forms, and requiring staff to manually store patient information, requires an undesirable amount of time and is error prone, such as in transcribing patient information from the patient record forms into the electronic database.

### SUMMARY OF THE INVENTION

In light of the foregoing background, embodiments of the present invention provide improved systems, methods, and computer program products for managing patient information, such as medical information, dental information and the like. Embodiments of the present invention provide patients a portal to create and maintain their own patient records, which can be stored in an electronic database, such as an electronic database that can be under the control of a legacy patient management software program (e.g., Eaglesoft Practice Management, PracticeWorks Office, SoftDent, Dentrix, etc.). To protect the electronic database, such as from erroneous and/or duplicative information, the system of one advantageous embodiment allows created and updated patient records to be stored in a queue, and thereafter be accepted by an administrator (e.g., medical or dental office staff) before being stored in the electronic database. The system of another advantageous embodiment allows patients to view at least a portion of the patients' medical records, such as contact information, previous appointment information, insurance and payment information. In addition, patients can be capable of confirming appointments with doctors or dentists prior to the patients' visit, thereby reducing the number of confirmation calls a medical or dental practice must make prior to patients' visits.

According to one aspect of the present invention, a system is provided for managing at least one patient record, each patient record including patient information. The system includes a patient processor, an administrator processor coupled to the patient processor across a network, and an electronic database coupled to the administrator processor. In this regard, the electronic database may be located remote from the patient processor across the network. The patient processor is capable of receiving patient information for a patient record, and storing the received patient information in a queue. The administrator processor is capable of thereafter receiving a determination whether to accept or reject the patient information in the queue. Like the electronic database, the queue may be located remote from the patient processor across the network. Before receiving the determination, the administrator processor can be capable of driving a display to present the received patient information such that the received patient information can be verified.

If the patient information is accepted, the electronic database is capable of storing the patient information. Irrespective of whether the patient information is accepted or rejected, the administrator processor also can be capable of deleting the patient information from the queue. For example, the administrator can delete the patient information from the queue after receiving the determination if the patient information is rejected, and after storing the patient information if the patient information is accepted.

The electronic database can be capable of storing at least one patient record, including at least one patient record including accepted patient information. In such instances, the patient processor can be capable of accessing a patient record from the electronic database, and thereafter receiving patient information including at least one modification to at least a portion of the patient information in the accessed patient record. Additionally, or alternatively, the electronic database can be capable of storing appointment information, account information, prescription information and/or insurance claim information associated with at least one patient record. In this regard, the patient processor can be capable of accessing the appointment information, account information, prescription information and/or insurance claim information. Further, the electronic database may be capable of storing at least one patient record including patient information having at least one appointment. As such, the patient processor can be capable of accessing at least one appointment from patient information in a patient record stored in the electronic database. Thereafter, the patient processor can receive a confirmation for at least one accessed appointment.

According to other aspects of the present invention, an improved method and computer program product are provided for managing patient information. Embodiments of the present invention provide patients a portal to create and maintain their own patient records, which can be stored in an electronic database, such as an electronic database that can be under the control of a legacy patient management software program. Advantageously, to protect the electronic database, such as from erroneous and/or duplicative information, new and/or modified patient records may be stored in a queue, and thereafter accepted or rejected by an administrator (e.g., medical or dental office staff) before being stored in the electronic database. In this regard, if the new and/or modified patient information is accepted, the information may be stored in the electronic database. Otherwise, if the new and/or modified patient information is rejected, the information is not stored in the electronic database, but instead may be deleted from the queue. Therefore, the system, method and computer program product of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a system for managing patient records according to one embodiment of the present invention;

FIGS. 2A and 2B are flow charts illustrating various steps in a method of managing patient records according to one embodiment of the present invention; and

FIGS. 3-22 illustrate exemplar Web browser formatted Web pages that may be presented during operation of a method of managing patient records according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

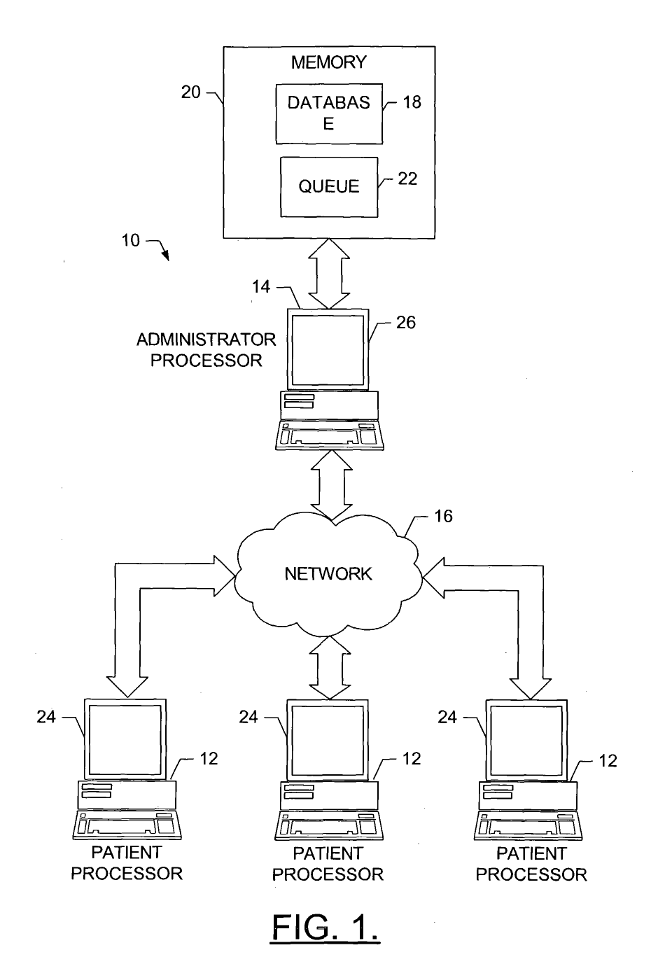

Referring to FIG. 1, a system 10 is shown for managing patient information, such as may be included in medical patient records, dental patient records or the like. The system includes at least one patient processor 12 operated or otherwise under the control of at least one user such as a patient. In this regard, as described herein, a user of a patient processor will be referred to as the patient, although it should be understood that the user need not be a patient. The system also includes an administrator processor 14 operated, or otherwise under the control of, an administrator such as staff of a dental practice. Similar to the user of the patient processor, as described herein, a user of a administrator processor will be referred to as the administrator, although it should be understood that the user need not be an administrator. As further described herein, the functions of each of the patient processor and the administrator processor will be described as being performed by the respective processor. It should be understood, however, that the functions of each processor may be performed by more than one processor in a distributed manner. For example, although not shown, the system can further include a separate staff processor capable of communicating with the administrator processor, such as to control operation of various functions of the administrator processor.

The patient processor 12 and administrator processor 14 can comprise any of a number of different processing devices including, for example, a server computer, personal computer, laptop computer, handheld computer or other high level processor. In one particularly advantageous embodiment, for example, the patient processor comprises a tablet PC that can operate in accordance with embodiments of the present invention. The patient processors and the administrator processor are capable of communicating with one another via a network 16. The network can comprise any of a number of different networks including, for example, a local area network (LAN), a metropolitan area network (MAN) or a wide area network (WAN), as such are well known to those skilled in the art. In one more particular embodiment, for example, the network can comprise the Internet.

The administrator processor 14 is coupled to, or otherwise in control of, an electronic database 18. The electronic database is capable of storing patient information in patient records such as those described above in the background section. The patient information can include any of a number of different types of information including, for example, contact information, medical history information, insurance information and the like. In this regard, the electronic database can comprise any of a number of different legacy electronic databases capable of storing patient information, such as an electronic database maintained by software programs such as Eaglesoft Practice Management, PracticeWorks Office, SoftDent or Dentrix. As will be appreciated, the electronic database is typically stored within a memory, such as non-volatile memory 20, coupled to the administrator processor.

As will also be appreciated, although shown and described as being distributed from the administrator processor 14, the electronic database 18 can be co-located with the administrator processor, without departing from the spirit and scope of the present invention. In this regard, according to a number of different techniques for storing and accessing patient information, patient information is stored in an remote database operated by a database operator. Portions of the patient information can then be downloaded to the electronic database, where the downloaded portions can be modified, deleted or the like, and additional patient information can be stored in the electronic database. And although the downloaded patient information in the electronic database is modified, deleted or the like, or new patient information is stored in the electronic database, the patient information in the remote database is not updated until the downloaded patient information including the changes, or the new patient information, is uploaded to the remote database. In one advantageous embodiment of the present invention, and in contrast to such conventional techniques for storing patient information, the patient information may be accessed in real-time from the electronic database that may be co-located with the administrator processor. As such, modifications in, and/or additions to, the patient information need not be uploaded to a remote database to update the patient information.

The patient information stored in the electronic database 18 is capable of being created and/or maintained by patients, as well as the administrator. As described more fully below with respect to one advantageous embodiment, however, new or updated patient information may be stored in a queue 22 before the new or updated patient information is stored in the electronic database, particularly when the new or updated patient information is created or maintained by patients. Advantageously, by storing the new or updated patient information in the queue, the administrator can, and typically does, review and/or modify the created or updated patient information before the same is stored in the electronic database.

The queue 22 can comprise any element, device, system or the like capable of at least temporarily storing new or updated patent information. As shown, for example, the queue can comprise a database within the non-volatile memory 20 coupled to the administrator processor 14. In this regard, the queue is distributed from the administrator processor, and within the memory storing the electronic database 18. It will be appreciated, however, that the queue can be co-located with the administrator processor, without departing from the spirit and scope of the present invention. Similarly, the queue can be stored in memory distributed from the memory storing the electronic database, without departing from the spirit and scope of the present invention.

According to embodiments of the present invention, a method of managing patient information generally consists of two phases, a patient phase and an administrator phase. In the patient phase, a patient can create and/or maintain patient records, including patient information, stored in the electronic database 18. For example, new patients are capable of creating a patient record via the patient processor 12 by entering patient information. Similarly, for example, existing patients can be capable of maintaining a patient record via the patient processor by verifying and/or modifying existing patient information. The patient record can be created in any of a number of different manners. For example, the patient record can be created by entering patient information into fields of a conventional Web browser formatted Web page presented by a display 24 coupled to a patient processor. The patient information can include any of a number of different pieces of information, such as contact information and medical history information. Additionally, the patient information can include other types of information, such as insurance information, electronic signatures, acknowledgement of various documents and the like.

In addition to creating and/or maintaining patient records in the electronic database 18, patients can be capable of viewing a number of different pieces of information stored in the electronic database. For example, patients may be capable of viewing previously stored patient information, past and future appointments with dental or medical personnel, and account history including past and present account balances. Advantageously, patients may also be capable of confirming upcoming appointments. By allowing patients to confirm their own appointments, dental or medical personnel need not initiate confirmation of scheduled, but already previously, appointments, such as by calling the respective patients with a reminder of an upcoming appointment.

To protect the electronic database 18, such as from unauthorized storage of patient information, when a patient (or even the administrator) creates and/or modifies a patient record in the electronic database, the created and/or modified patient information is stored in the queue 22. The new or modified patient information can thereafter be verified by the administrator. The new or modified patient information can be verified in any of a number of different manners, but in one embodiment the new or modified patient information is verified for correctness and acceptance into the electronic database, as described more fully below.

According to one embodiment, in the administrator phase, the administrator is capable of viewing created and modified patient information stored in the queue. In this regard, the administrator processor is capable of presenting on a display 26 all of the created and modified patient information, such as by selecting a particular patient from a summary display. The administrator can then be capable of viewing all of the entered and modified patient information and independently verifying the information. For example, the administrator can view a newly created patient record including new patient information to verify the new patient information, including any insurance information provided by the patient.

After verifying the created and/or modified patient information, the administrator can then select whether to accept or reject the patient information into the electronic database 18. In this regard, if the patient information is accepted, the respective patient information can be moved from the queue 22 and stored in the electronic database, either creating a new patient record or merging and updating an existing patient record. If the patient information is rejected, on the other hand, the respective patient information is not moved into the electronic database. At this point, the system 10 can respond to rejecting the patient information in any number of different manners. For example, the administrator processor 14 can delete the patient information from the queue. Additionally, or alternatively, the administrator processor can send a notification to the respective patient processor 12, such as in an email via the network 16, where the notification indicates that the patient information has been rejected. After accepting or rejecting the respective patient information, the administrator can continue with other created and/or modified patient records stored in the queue. For each created and modified patient record, then, the administrator can repeat the verification process by verifying, and accepting or rejecting, the information for the respective patient information.

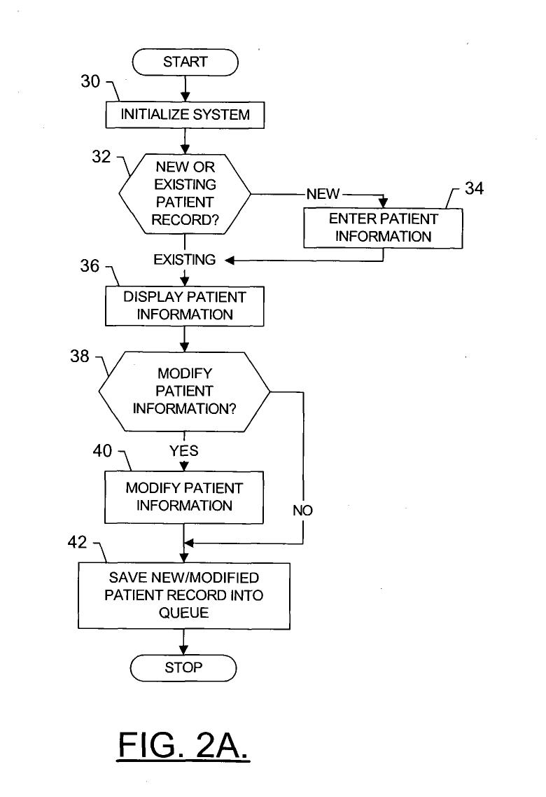

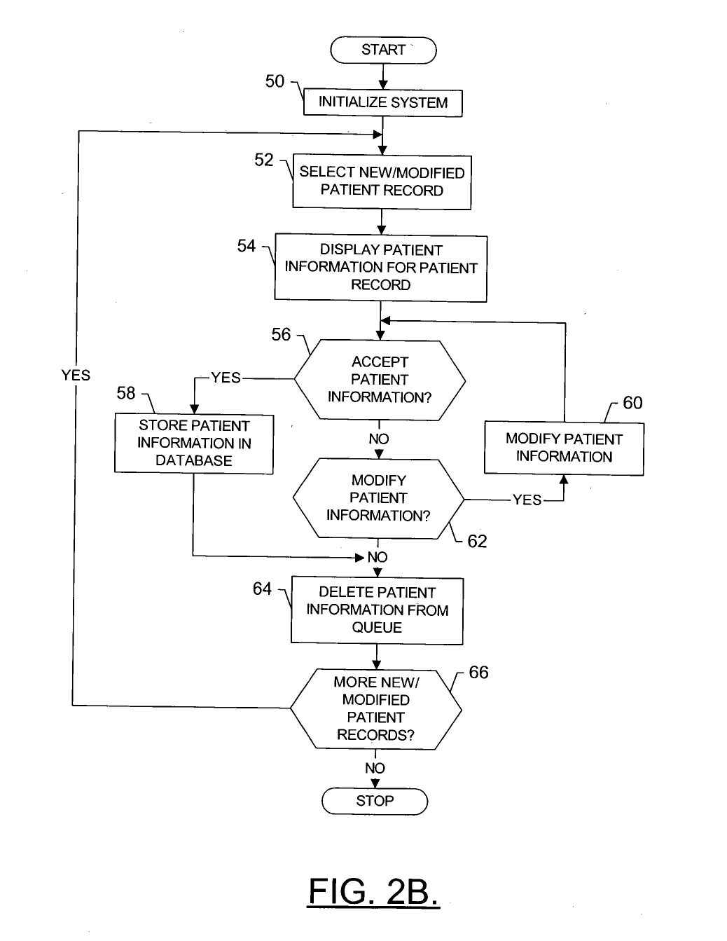

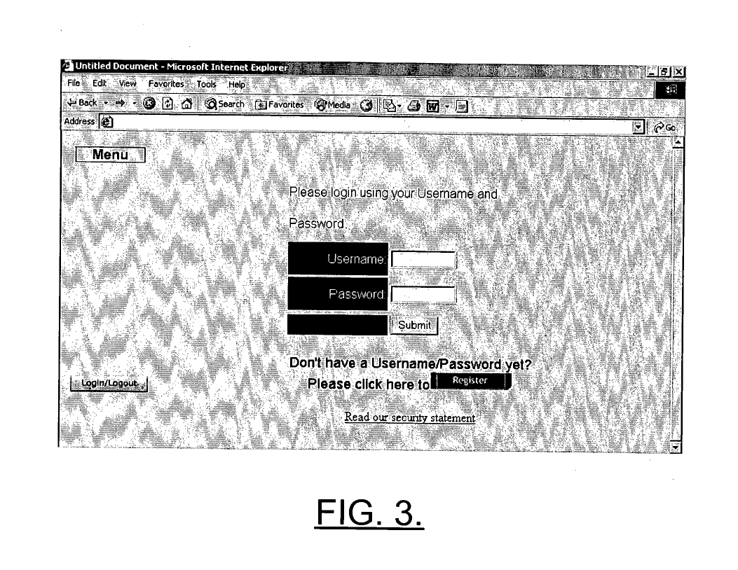

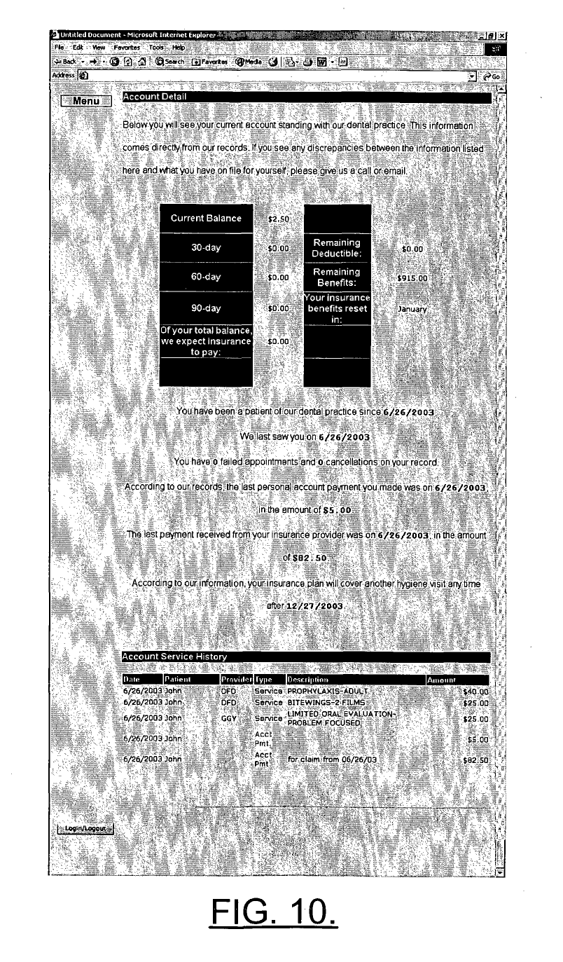

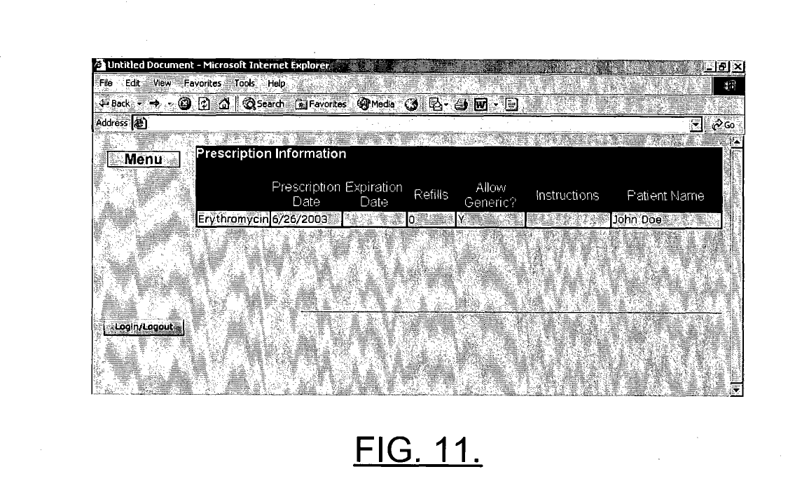

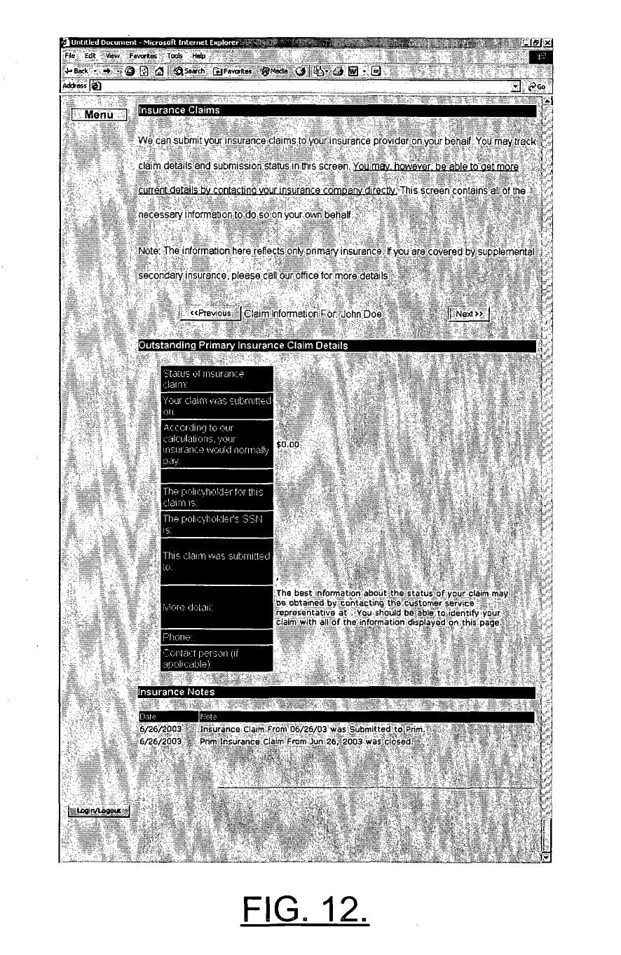

Reference is now made to FIGS. 2A and 2B, which illustrates a flow chart including various steps in a method of maintaining patient information according to one embodiment of the present invention. As described, according to one embodiment, various steps of the method can be performed by the patient processor 12 and/or administrator processor 14 operating a connectivity program such as a conventional Web browser to present Web pages on display 24 and/or display 26, respectively, for receiving and/or presenting instructions, information or the like in accordance with a method of maintaining patient information. In this regard, reference is also made to FIGS. 3-22, which illustrate exemplar Web browser formatted Web pages that may be presented by display 24 and/or display 26 during operation of a method of managing patient records according to embodiments of the present invention.

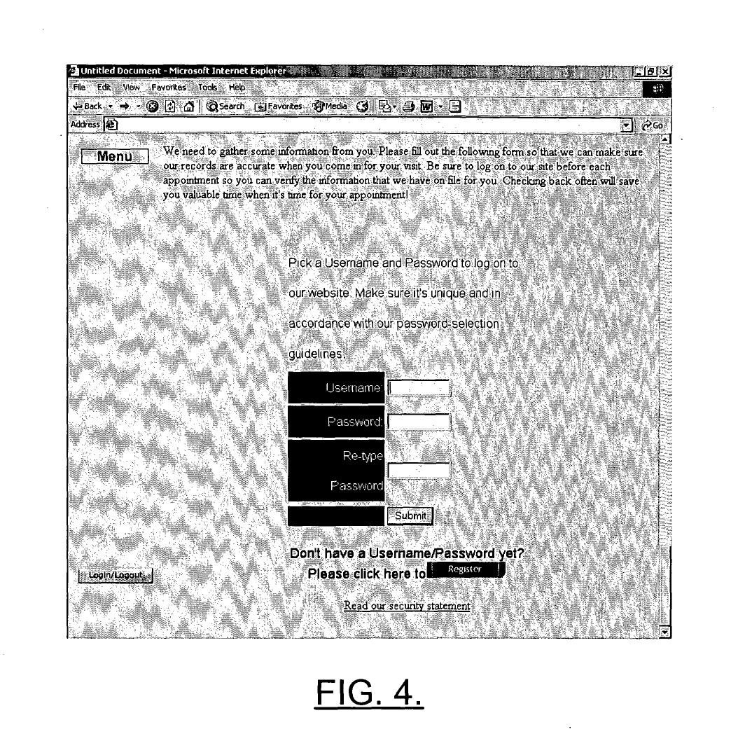

As shown in FIGS. 2A and 2B, in one embodiment, a method of maintaining patient information may begin with a patient initializing a system for maintaining patient information, such as by utilizing a patient processor 12 to access a portal maintained, or otherwise related to, the administrator processor 14, as shown in block 30. For example, as shown in FIG. 3, a dental patient may initialize a system for maintaining patient information by accessing a portal associated with a particular dentist or dental practice. After initializing the system, although not shown in FIGS. 2A and 2B, the patient may be prompted to select whether the patient has registered with the system 10. And as shown in FIG. 4, if the patient has not registered with the system, the patient may at this time register by selecting a username and password.

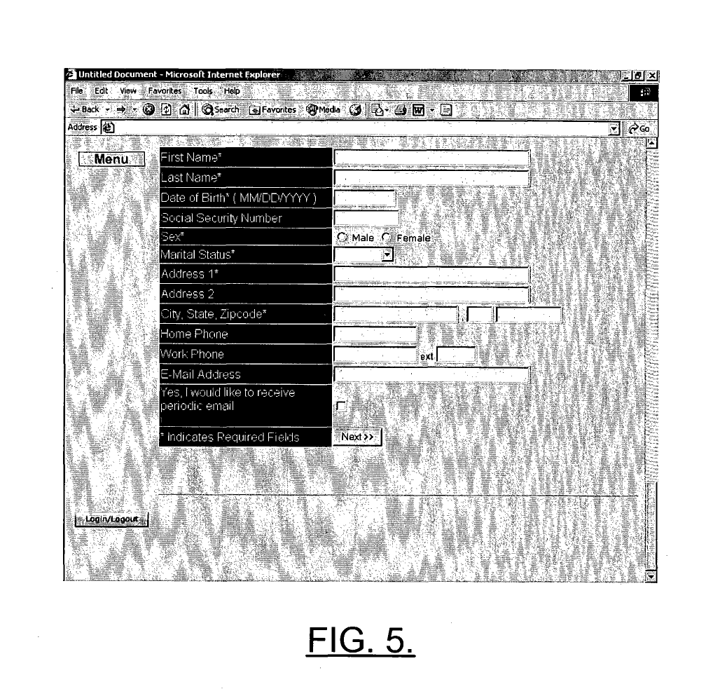

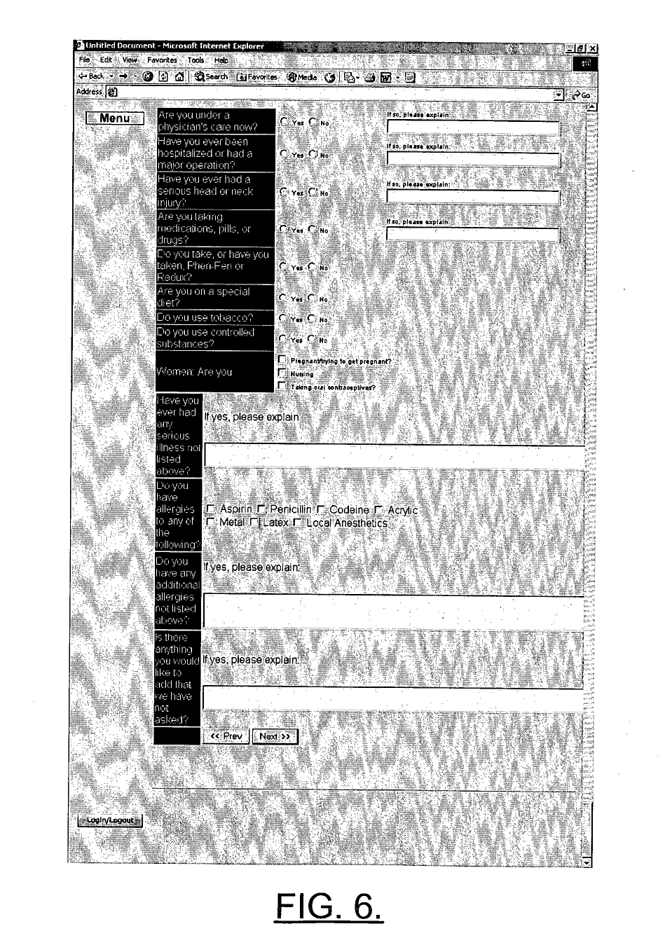

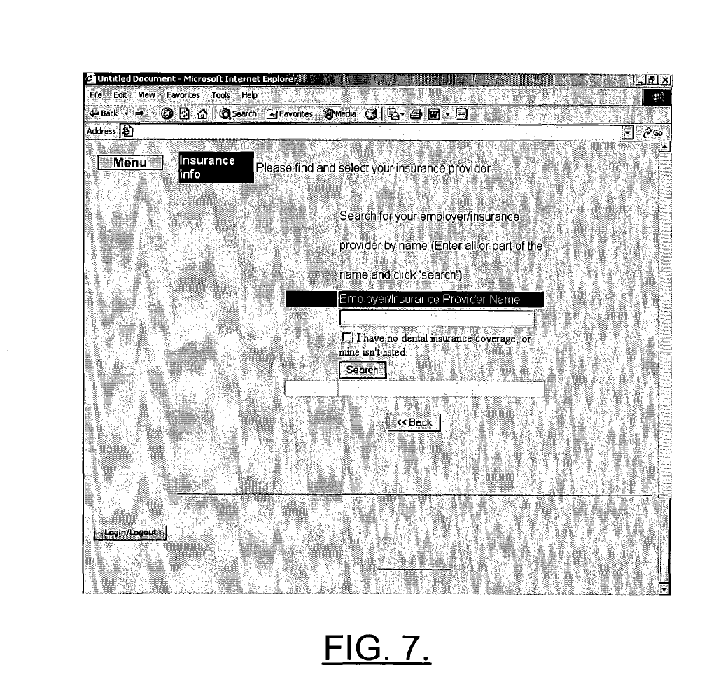

After the patient has initialized the system 10 (or after the patient has registered with the system) the patient may be prompted to select whether the patient has an existing patient record or is creating a new patient record, as shown in block 32. If the patient indicates that the patient desires to create a new patient record, the patient may be prompted to enter, and thereafter enter patient information, as shown in block 34. The patient may be prompted in any of a number of different manners, such as by presenting the patient with one or more electronic forms including one or more fields for entering patient information. For example, as shown in FIGS. 5 and 6, the patient may be prompted to enter patient information including identifying contact information (FIG. 5) and/or medical history information (FIG. 6). Additionally or alternatively, for example, the patient information may include insurance information, and as such, the patient may be prompted to enter such insurance information, as shown in FIG. 7 with an insurance provider for the patient capable of being selected based upon an employer associated with the patient.

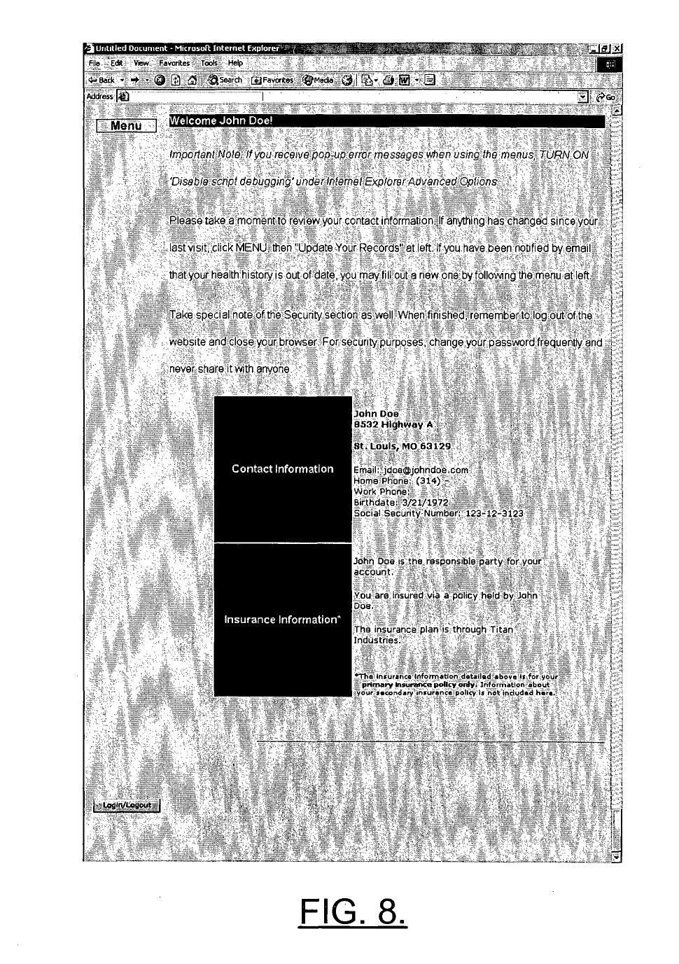

After the patient has entered the patient information to create a new patient record, the patient may, but need not, be presented with a display of the entered patient information, such as to verify the accuracy of the entered information, as shown in block 36. Similarly, if the patient already has an existing patient record, the patient may be presented with a display of the patient information currently stored in the electronic database 18 for the respective patient record. For example, as shown in FIG. 8, the patient may be presented with the patient information, including the contact information, medical history information and/or insurance information.

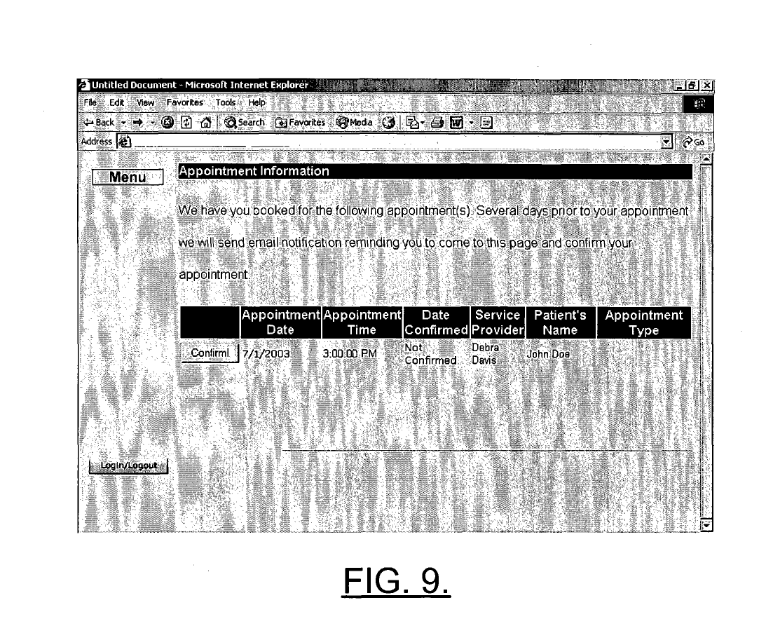

In addition to being presented with the patient information, the patient may be presented with other information included within, or related to, the respective patient or the respective patient record. For example, as shown in FIGS. 9, 10, 11 and 12, the patient may be presented with appointment information, account information, prescription information and insurance claim information, respectively. Advantageously, by presenting the patient with appointment information, the patient may be capable of verifying and/or confirming a future appointment, such as by selecting a button (e.g., “Confirm!”) that causes the patient processor 12 to send a confirmation message. The confirmation can be sent to the queue 14 such that the administrator can accept the confirmation into the electronic database 18. Alternatively, and in accordance with one advantageous embodiment of the present invention, the confirmation can be sent directly to the electronic database 18, without first passing through the queue or being accepted into the electronic database. Also, by presenting the patient with account information, the patient may be capable of verifying account information, such as an account balance, and may be capable of paying any account balance. By allowing the patient to verify and/or confirm a future appointment, the number of confirmation calls a medical or dental practice must make prior to patients' appointments may be reduced.

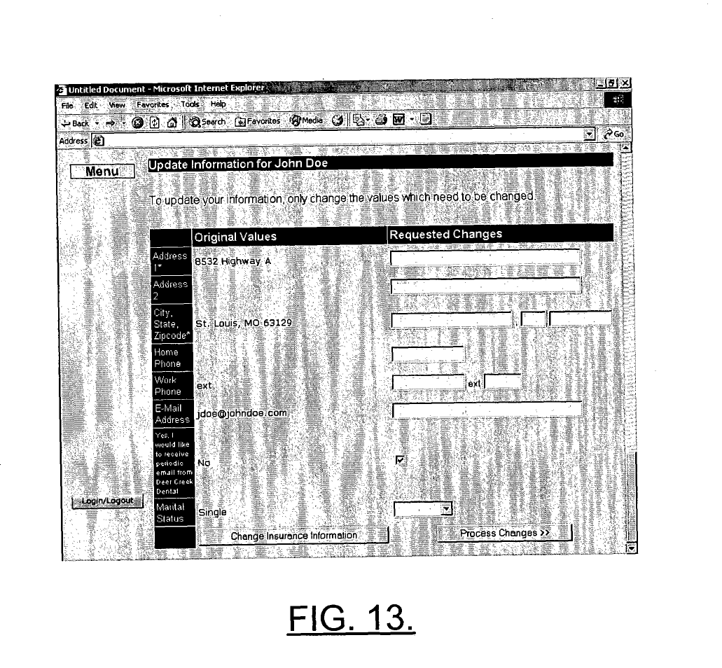

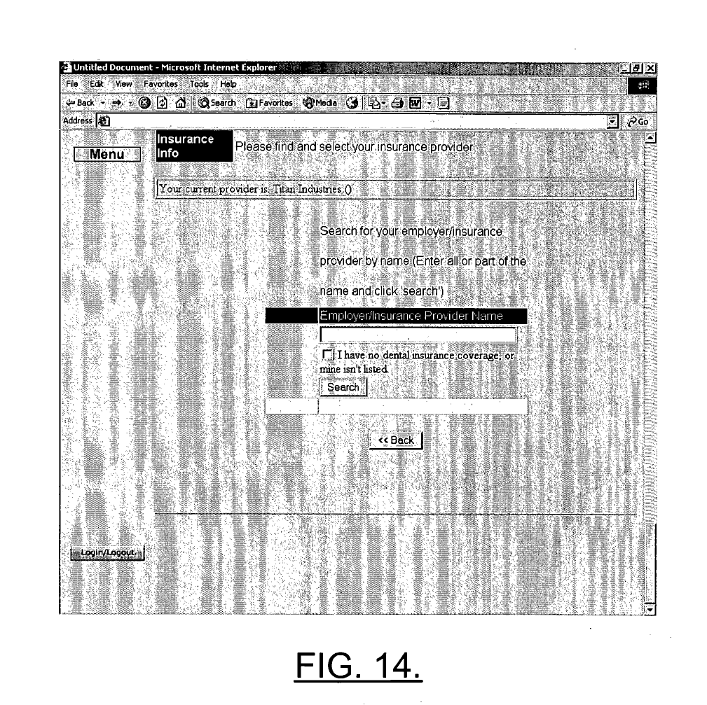

Either before, after or in lieu of being presented with a display of the patient information, a patient may select to modify patient information in the new or existing patient record, such as by adding, deleting and/or changing patient information, as shown in block 38. If the patient selects to modify patient information in the new or existing patient record, the patient may be prompted to modify the patient information, which the patient may thereafter modify, as shown in block 40. As before, the patient may be prompted in any of a number of different manners, such as by presenting the patient with one or more electronic forms including one or more fields for entering patient information. In this regard, the fields may, but need not, identify patient information currently associated with the respective fields such that the patient may recognize the patient information the patient desires to modify. For example, as shown in FIGS. 13 and 14, the patient may be prompted to modify patient information including contact information (FIG. 13) and/or insurance information (FIG. 14), and may also be prompted to modify medical history information (see FIG. 6).

After entering patient information in a new patient record, viewing and/or modifying the patient information in a new or existing patient record, the patient can select to process the new or modified patient record. In this regard, the new or modified patient record may be stored into the queue 22, as shown in block 42. As will be appreciated, all newly entered patient information is typically be stored in the queue. For existing patient records, however, all patient information for the respective patient record, or more typically only the modified patient information, is typically stored in the queue.

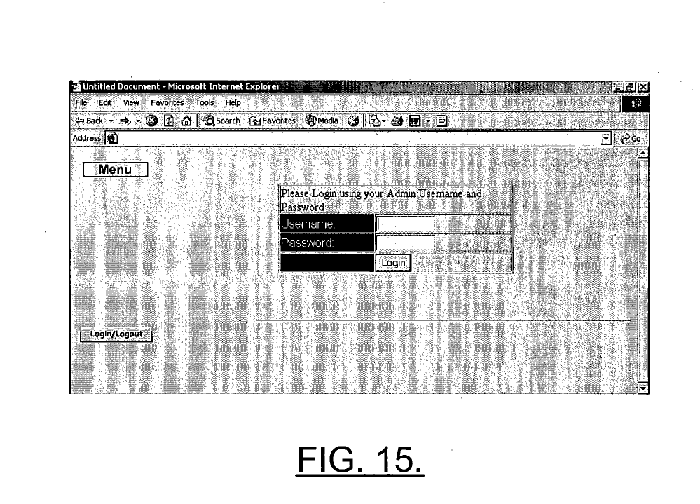

At any point subsequent to storing the new or modified patient information in the queue 22, the administrator (e.g., dental or medical staff) may access new and/or modified patient information for one or more patients, such as to verify the patient information for storage into the electronic database 18. The administrator may access the new and/or modified patient information in any of a number of different manners. In one embodiment, for example, the administrator may access the new and/or modified patient information by first initializing a system for maintaining patient information, such as by accessing an administrative portal maintained by, or otherwise related to, the administrator processor, as illustrated in block 50 of FIG. 2B. For example, as shown in FIG. 15, administrator may initialize a system for maintaining patient information by accessing an administrative portal associated with a particular dentist or dental practice.

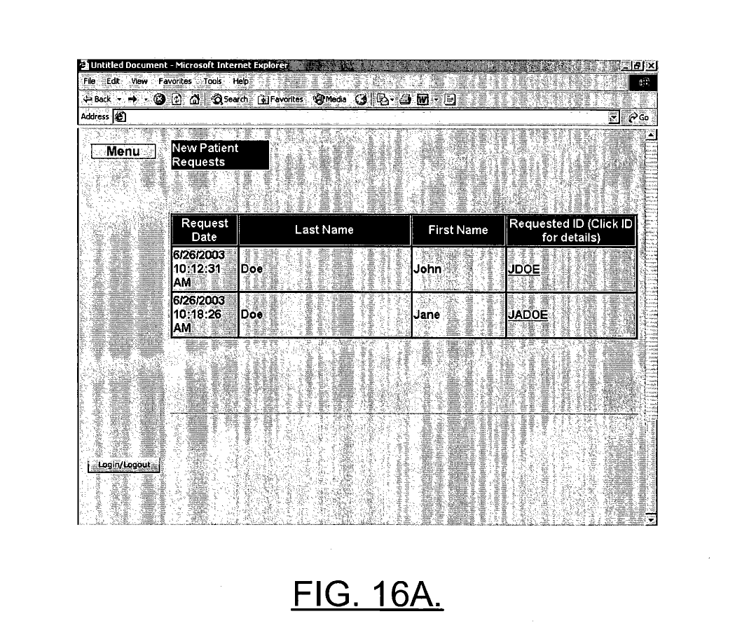

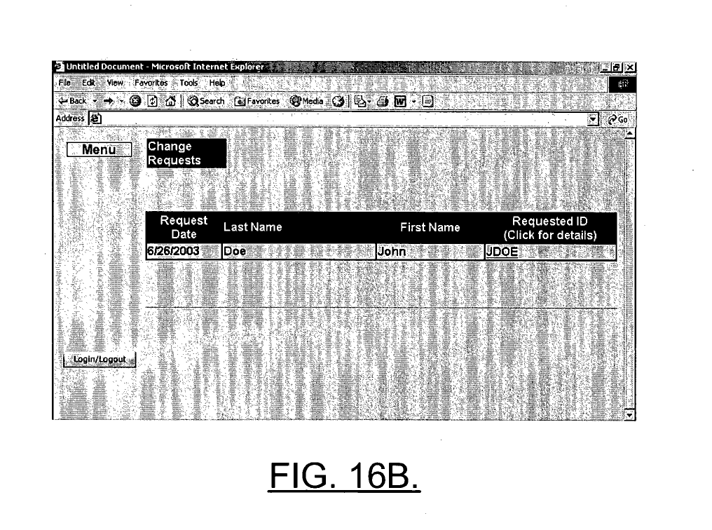

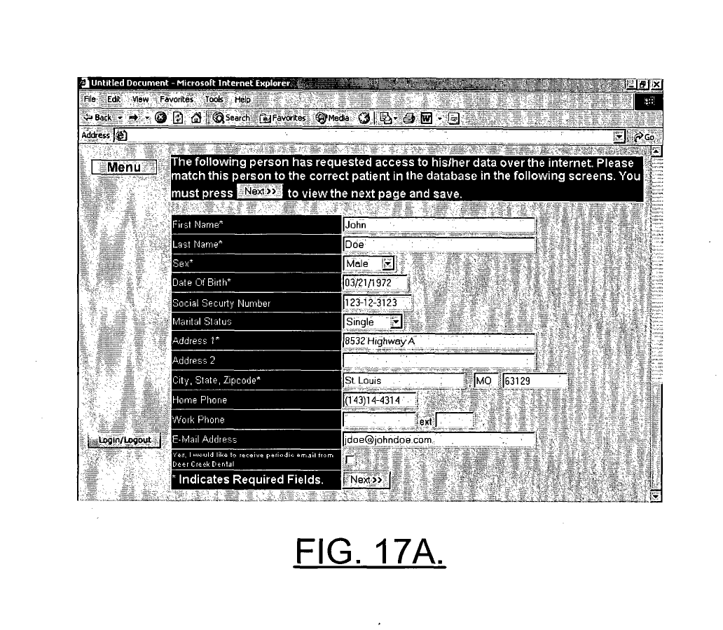

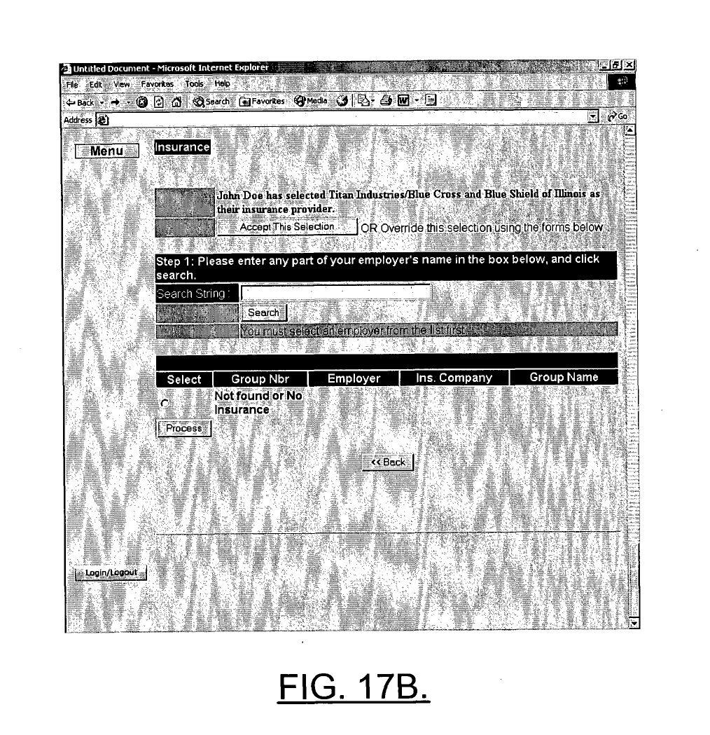

After initializing the system, the administrator may use the administrator processor 14 to select new and/or modified patient information for one or more patients, such as from the queue. More particularly, for example, the administrator can select a patient medical record to access, such as from a list of new and modified patient records, as shown in block 52. For example, the administrator can select a patient medical record from a list of new patient records or a list of modified patient records, as shown in FIGS. 16A and 16B, respectively. Irrespective of how the administrator selects a new or modified patient record, after selecting such a patient record, the administrator processor may drive the display 26 to present the patient information included within the patient record, as shown in block 54. The patient information can be presented in any of a number of different manners, such as in a manner similar to presenting the patient information to the administrator. As shown in FIGS. 17A and 17B, for example, the patient information for a new patient record can be presented in form fields within an electronic form. Also, for example, the patient information for a modified patient record may be presented in form fields including the modified patient information, where the form fields may identify the patient information in the electronic database currently associated with the respective fields such that the administrator may recognize the patient information the patient (e.g., patient) desires to modify.

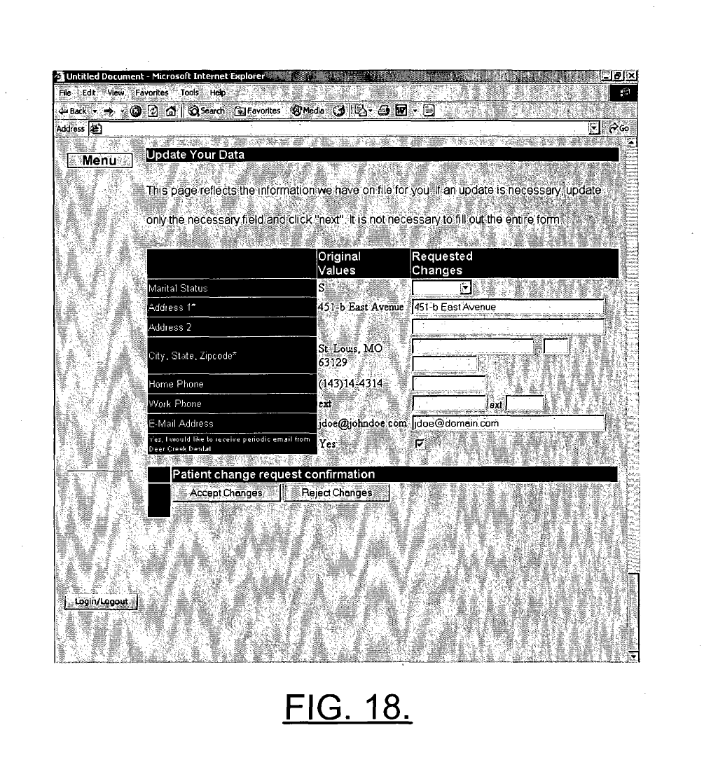

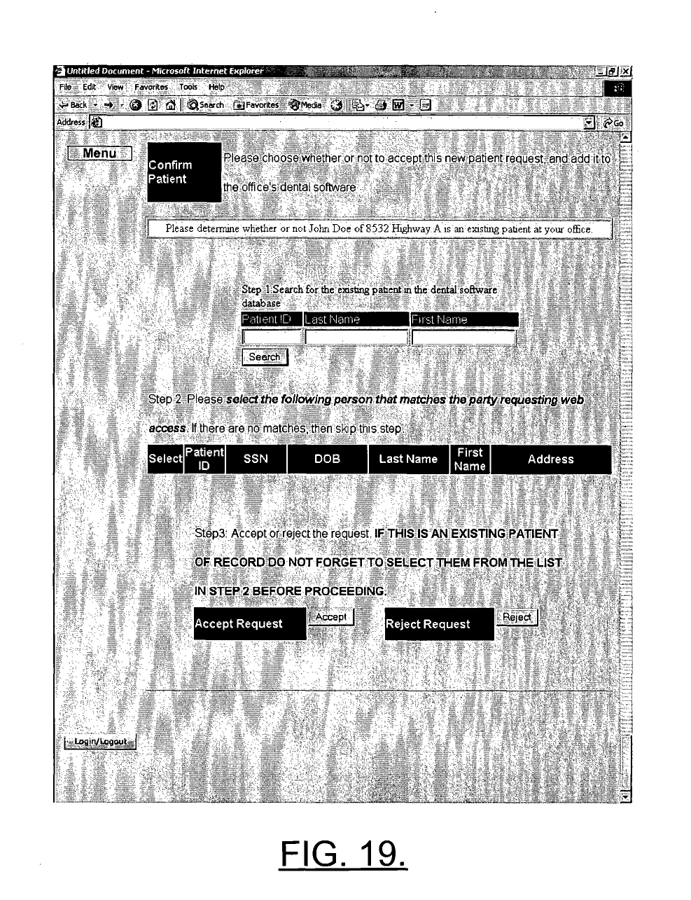

After the new or modified patient information has been presented, the administrator may select to accept or reject the patient information, as shown in block 56. The administrator may select to accept or reject the new or modified patient information in any of a number of different manners. For example, as shown in FIGS. 18 and 19, the administrator may select to accept or reject the patient information by selecting either a button associated with accepting the patient information (“Accept Changes,” “Accept”), or a button associated with rejecting the patient information (“Reject Changes,” “Reject”). In this regard, if the administrator accepts the new or modified patient information, the new or modified patient information can be stored in the electronic database 18, as shown in block 58. Thereafter, the new or modified patient information can be deleted from the queue, as shown in block 64.

If the administrator does not desire to accept the new or modified patient information, the administrator may be capable of modifying the new or modified patient information, as well as unmodified patient information included within the same patient record as the modified patient information, as shown in blocks 62 and 60. If the administrator modifies any patient information, the administrator may again be capable of accepting or rejecting the new or modified patient information, as well as again modifying patient information, such as in a manner described above with respect to blocks 56, 58 and 62. On the other hand, if the administrator does not desire to modify any patient information, or if the administrator does not desire to accept the new or modified patient information even after modifying at least a portion of the patient information, the new or modified patient information is not stored in the electronic database 18. In such instances, the administrator processor 14 can respond in any of a number of different manners including, for example, deleting the new or modified patient information from the queue 22, as shown in block 64.

After accepting or rejecting the new or modified patient information, the administrator may desire to select another new or modified patient record, as shown in block 66. In this regard, the administrator may repeatedly select, view and accept/modify/reject a number of new and/or modified patient records, such as in the same manner as described above. For example, the administrator may be capable of selecting another new or modified patient record from the list of new patient records or modified patient records, as shown in FIGS. 16A and 16B. In this manner, the administrator may advantageously verify all patient information before the patient information is stored in the electronic database, particularly when a patient has entered or modified the patient information. Thus, the administrator may protect the electronic database 18, such as from unauthorized storage of patient information.

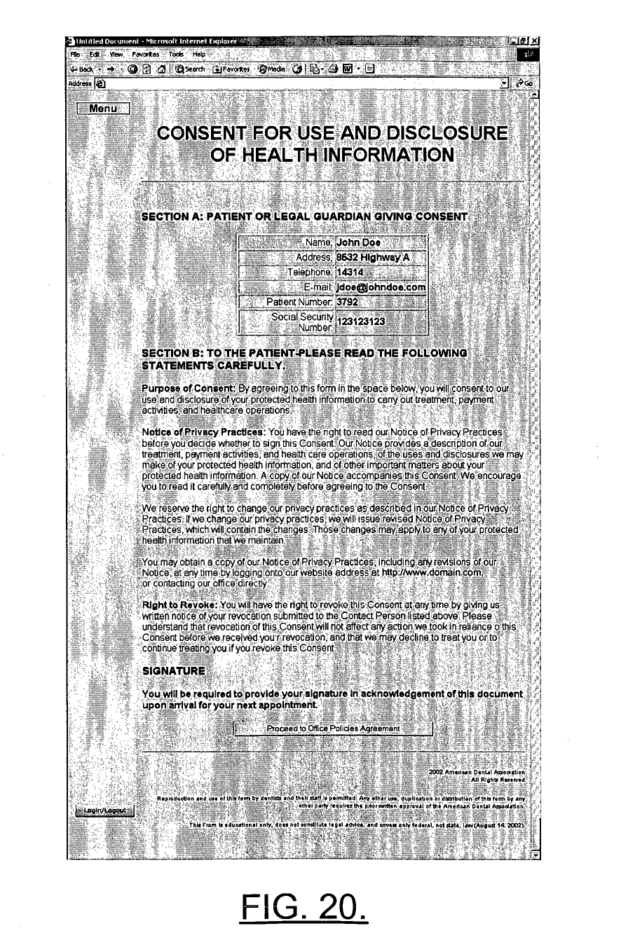

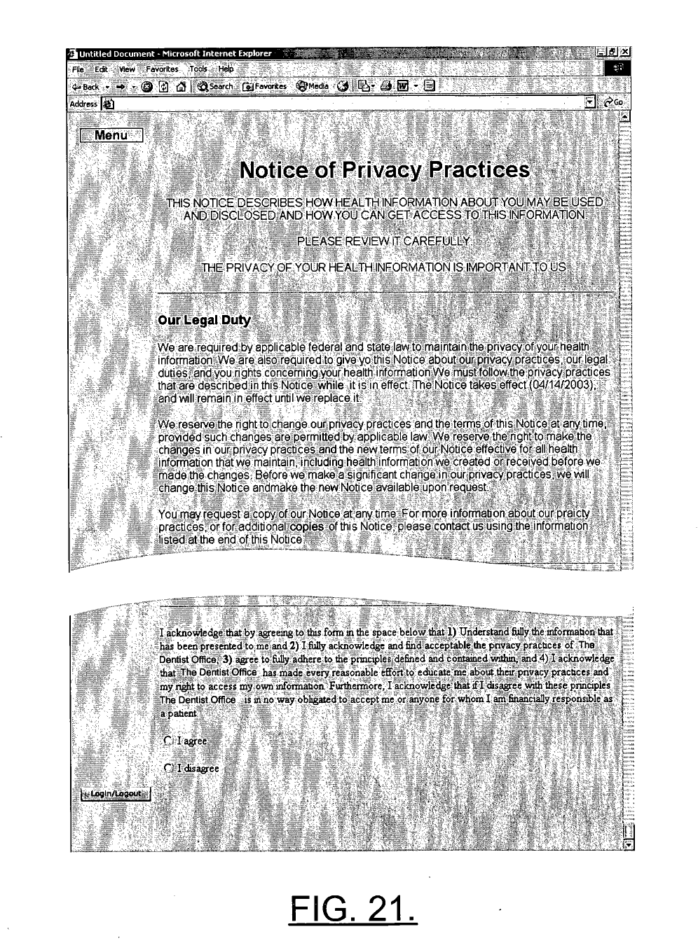

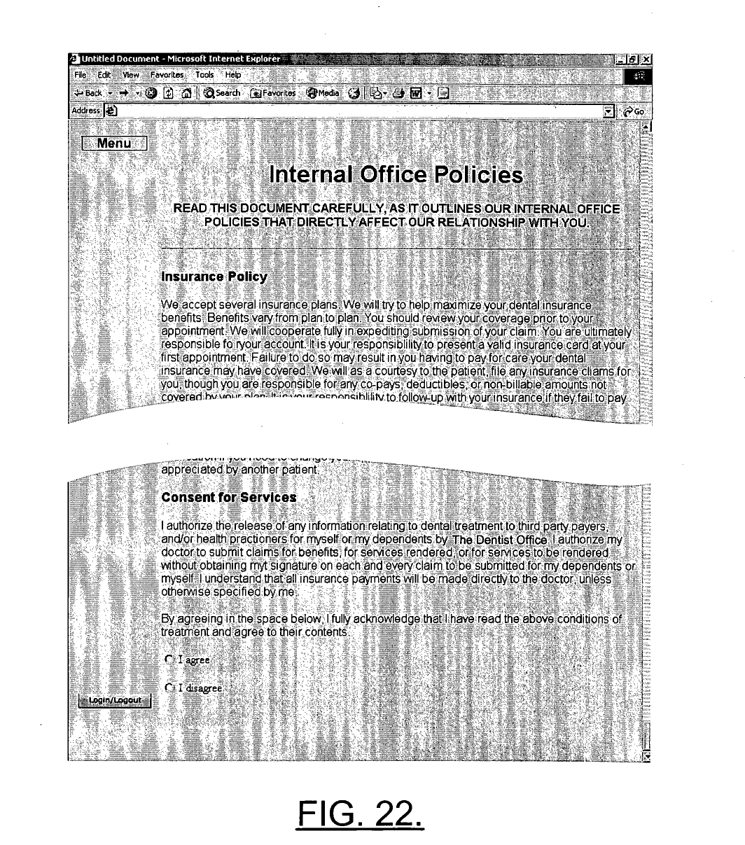

After a patient has created a new patient record, and the information in the patient record has been accepted by the administrator for storage in the electronic database 18, the patient may access the patient record, such as to view the patient information and/or other information (e.g., appointment information, account information, prescription information and insurance claim information). In one embodiment, however, before the patient accesses a patient record after the respective patient information has been stored in the electronic database, the system 10 may require the patient to review (or at least require the display 24 to present) one or more documents, such as a HIPAA (Health Insurance Portability and Accountability Act) privacy statement, an informed consent, an office policies statement, a medical history document and/or a signature-on-file document. Upon reviewing the documents, the system may require the patient to acknowledge and/or accept the documents to access the patient record. For example, as shown in FIGS. 20, 21 and 22, the patient may be required to review an informed consent (FIG. 20), a privacy statement (FIG. 21) and an internal office policies statement (FIG. 22).

As will be appreciated, in various instances patient authorization may be required in relation to the patient and/or the patient record, such as to authorize payment of an account balance. Thus, in one embodiment of the present invention, the patient information may include a digital signature of the patient. The digital signature may be obtained in any of a number of different manners. For example, the digital signature may be obtained by scanning a handwritten signature into a digital representation of the signature. Also, for example, the digital signature may be obtained utilizing a pen-enabled computing device, such as a tablet personal computing device, that includes an electronic writing tablet and a writing stylus. Irrespective of how the digital signature is obtained, however, the digital signature may be utilized to provide authorizations and/or to indicate an authorization otherwise provided, such as in connection with printed copies of such authorizations.

As will also be appreciated, in various instances a patient may require some form of patient record before creating a patient record in a manner as described above. For example, in various instances a patient may arrive at a medical or dental facility for an appointment before having first created a patient record for use by the respective facility. In such instances, the system may be capable of permitting the patient to create a “quick account,” or an abbreviated patient record, such as by utilizing a processor (e.g., a patient processor) at the respective facility. In this regard, the abbreviated patient record may be created in a manner similar to that described above for creating a patient record, but include only that information necessary to access a patient record that is associated with the patient. For example, the abbreviated patient record may include information such as a patient name, address, username and password. By creating the abbreviated patient record, the administrator may store patient information obtained during the appointment in the electronic database 18, and associate the patient information with the respective patient record. Also, by creating the abbreviated patient record, the patient may subsequently access the abbreviated patient record, such as via a patient processor 12, and enter further patient information to thereby create a complete patient record from the abbreviated patient record.

According to one aspect of the present invention, the system of the present invention, such as the patient processor 12 and/or the administrator processor 14, generally operates under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 2A and 2B are flowcharts of methods, systems and program products according to the invention. It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Many modifications and other embodiments of the invention will come to mind to one skilled in the art to which this invention pertains having the benefit of the teachings presented in the foregoing descriptions and the associated drawings. For example, the administrator processor 14 may further be capable of permitting a medical professional, such as a physician, dentist, nurse, physician/dentist assistant or the like, to manage one or more patients and other aspects of a medical or dental practice. More particularly, the administrator processor may be capable of receiving, and thereafter driving the display 26 to present, information related to the medical or dental practice. For example, the administrator processor may be capable of receiving, and the display may be capable of presenting, information such as past and/or future patient appointments, clinical notes for one or more patients for one or more days, and/or post-op calls for one or more days. Further with respect to clinical notes, the administrator processor may be capable of receiving unverified (i.e., unlocked) clinical notes, edit unverified clinical notes, and thereafter verify the unverified clinical notes, whether or not the unverified clinical notes have been edited after having been received by the administrator processor.

Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for managing at least one patient record, each patient record including patient information, the method comprising:
receiving, into a patient processor, patient information for a patient record;
storing the received patient information in a queue;
determining, from an administrator processor, whether to accept or reject the patient information in the queue; and
storing the patient information in an electronic database if the patient information is accepted.

2. A method according to claim 1 further comprising:
deleting the patient information from the queue, wherein the patient information is deleted from the queue after determining whether to accept or reject the patient information if the patient information is rejected, and after storing the patient information if the patient information is accepted.

3. A method according to claim 1 further comprising:
verifying the patient information before determining whether to accept or reject the patient information, wherein determining whether to accept or reject the patient information is based upon the verification.

4. A method according to claim 1, wherein the electronic database is capable of storing at least one patient record including patient information having at least one appointment, and wherein the method further comprises:
accessing at least one appointment from patient information in a patient record stored in the electronic database; and
electronically confirming the at least one appointment.

5. A method according to claim 1, wherein storing the received patient information in a queue comprises storing the received patient information in a queue located remote from the patient processor across a network, wherein determining whether to accept or reject the patient information comprises determining, from an administrator processor located remote from the patient processor across the network, whether to accept or reject the patient information, and wherein storing the patient information comprises storing the patient information in an electronic database located remote from the patient processor across the network.

6. A method according to claim 1 further comprising:
accessing, from the patient processor, a patient record from the electronic database, wherein receiving patient information comprises receiving at least one modification to at least a portion of the patient information in the accessed patient record.

7. A method according to claim 1 further comprising:
accessing at least one of appointment information, account information, prescription information and insurance claim information associated with a patient record.

8. A system for managing at least one patient record, each patient record including patient information, the system comprising:
a patient processor capable of receiving patient information for a patient record, wherein the patient processor is capable of storing the received patient information in a queue;
an administrator processor coupled to the patient processor across a network, wherein the administrator processor is capable of receiving a determination whether to accept or reject the patient information in the queue; and
an electronic database coupled to the administrator processor, wherein the electronic database is capable of storing the patient information if the patient information is accepted.

9. A system according to claim 8, wherein the administrator processor is also capable of deleting the patient information from the queue after receiving the determination if the patient information is rejected, and after storing the patient information if the patient information is accepted.

10. A system according to claim 8, wherein the administrator processor is capable of driving a display to present the received patient information such that the received patient information can be verified before the administrator processor receives the determination.

11. A system according to claim 8, wherein the electronic database is capable of storing at least one patient record including patient information having at least one appointment, wherein the patient processor is capable of accessing at least one appointment from patient information in a patient record stored in the electronic database, and wherein the patient processor is capable of receiving a confirmation for at least one accessed appointment such that the confirmation can be stored in the electronic database independent of the queue.

12. A system according to claim 8 further comprising the queue, wherein the queue is located remote from the patient processor across the network, and wherein the electronic database is located remote from the patient processor across the network.

13. A system according to claim 8, wherein the electronic database is capable of storing at least one patient record, wherein the patient processor is capable of accessing a patient record from the electronic database, and thereafter receiving patient information including at least one modification to at least a portion of the patient information in the accessed patient record.

14. A system according to claim 8, wherein the electronic database is capable of storing at least one of appointment information, account information, prescription information and insurance claim information associated with at least one patient record, and wherein the patient processor is capable of accessing the at least one of appointment information, account information, prescription information and insurance claim information.

15. A computer program product for managing at least one patient record, each patient record including patient information, the computer program product comprising a computer-readable storage medium having computer-readable program code portions stored therein, the computer-readable program portions comprising:
a first executable portion for receiving, into a patient processor, patient information for a patient record;
a second executable portion for storing the received patient information in a queue;
a third executable portion for receiving a determination, from an administrator processor, whether to accept or reject the patient information in the queue; and
a fourth executable portion for storing the patient information in an electronic database if the patient information is accepted.

16. A computer program product according to claim 15 further comprising:
a fifth executable portion for deleting the patient information from the queue after determining whether to accept or reject the patient information if the patient information is rejected, and after storing the patient information if the patient information is accepted.

17. A computer program product according to claim 15 further comprising:
a fifth executable portion driving a display to present the received patient information such that the received patient information can be verified before the third executable portion receives the determination.

18. A computer program product according to claim 15, wherein the electronic database is capable of storing at least one patient record including patient information having at least one appointment, and wherein the computer program product further comprises:
a fifth executable portion for accessing at least one appointment from the patient information in a patient record stored in the electronic database; and
a sixth executable portion for receiving a confirmation of the at least one appointment.

19. A computer program product according to claim 15 further comprising:
a fifth executable portion for accessing, from the patient processor, a patient record from the electronic database, wherein the first executable portion receives patient information comprising at least one modification to at least a portion of the patient information in the accessed patient record.

20. A computer program product according to claim 15 further comprising:
a fifth executable portion for accessing at least one of appointment information, account information, prescription information and insurance claim information associated with a patient record.
